(19) United States
(12) Patent Application Publication
(10) Pub. No.: US 2026/0210528 A1
(43) Pub. Date: Jul. 23, 2026

(54) MULTIDIRECTIONAL LIGHTING ASSEMBLY

(71) Applicant: Shining Sea Trading Company, West Valley City, UT (US)

(72) Inventor: Jared Hendricks, Draper, UT (US)

(21) Appl. No.: 19/429,909

(22) Filed: Dec. 22, 2025

Related U.S. Application Data
(63) Continuation-in-part of application No. 18/751,190, filed on Jun. 21, 2024.
(60) Provisional application No. 63/898,333, filed on Oct. 13, 2025.

(51) Int. Cl. F21V 13/02; F21V 5/00; F21V 15/01; F21V 17/06; F21W 131/107; F21Y 115/10

(52) U.S. Cl. CPC F21V 13/02; F21V 5/007; F21V 15/01; F21V 17/06; F21W 2131/107; F21Y 2115/10

(57) ABSTRACT

A multidirectional lighting device includes a display light base carrying a display light emitter, the display light base being substantially opaque, and an accent light emitter. A display lens receives light from the display light emitter. An at least partially translucent housing carries an accent lens, the housing including a display lens opening through which the display lens protrudes. A light blocking ring: substantially circumscribing a portion of the display light emitter; fittable within the display lens opening of the housing; and is positioned atop the display light base. The light blocking ring is operable to block light emitted from the display lens from entering the housing so that light emitted from the display lens is isolated from light emitted by the accent light.

### CROSS-REFERENCE TO RELATED APPLICATIONS

This application claims priority claimed of and to U.S. Provisional Patent Application Ser. No. 63/898,333, filed Oct. 13, 2025, and is a continuation-in-part of U.S. patent application Ser. No. 18/751,190, filed Jun. 21, 2024, which claims benefit of and to U.S. Provisional Ser. No. 63/509,471, filed Jun. 21, 2023, all of which are incorporated herein by reference in their entirety.

### BRIEF DESCRIPTION OF THE DRAWING

FIG. 1 presents an illustration of lighting devices on a track in accordance with an example embodiment of the technology;

FIG. 2 presents an illustration of a lighting device coupled to a lighting support in accordance with an example embodiment;

FIG. 3 presents an illustration of a lighting device coupled to a lighting support in accordance with an example embodiment;

FIG. 4 presents an illustration of lighting devices coupled to a lighting support in accordance with an example embodiment;

FIG. 5A presents a side view illustration of a lighting device in accordance with an example embodiment;

FIG. 5B presents a side view illustration of a lighting device in accordance with an example embodiment;

FIG. 6 presents a top view illustration of a lighting track device in accordance with an example embodiment;

FIG. 7 presents an illustration of lighting device coupled to a lighting support in accordance with an example embodiment;

FIG. 8 presents an illustration of lighting device coupled to a lighting support in accordance with an example embodiment;

FIG. 9A presents a side view illustration of a lighting device in accordance with an example embodiment;

FIG. 9B presents a side view illustration of a lighting device in accordance with an example embodiment;

FIG. 10A presents various views of a lighting device in accordance with an example embodiment;

FIG. 10B presents various views of a lighting device in accordance with an example embodiment;

FIG. 10C presents various views of a lighting device in accordance with an example embodiment;

FIG. 10D presents various views of a lighting device in accordance with an example embodiment;

FIG. 10E presents various views of a lighting device in accordance with an example embodiment;

FIG. 10F presents various views of a lighting device in accordance with an example embodiment;

FIG. 11A presents various views of a lighting device in accordance with an example embodiment;

FIG. 11B presents various views of a lighting device in accordance with an example embodiment;

FIG. 11C presents various views of a lighting device in accordance with an example embodiment;

FIG. 11D presents various views of a lighting device in accordance with an example embodiment;

FIG. 11E presents various views of a lighting device in accordance with an example embodiment;

FIG. 11F presents various views of a lighting device in accordance with an example embodiment;

FIG. 12A presents various views of a lighting device having an aesthetic filter in accordance with an example embodiment;

FIG. 12B presents various views of a lighting device having an aesthetic filter in accordance with an example embodiment;

FIG. 12C presents various views of a lighting device having an aesthetic filter in accordance with an example embodiment;

FIG. 12D presents various views of a lighting device having an aesthetic filter in accordance with an example embodiment;

FIG. 12E presents various views of a lighting device having an aesthetic filter in accordance with an example embodiment;

FIG. 12F presents various views of a lighting device having an aesthetic filter in accordance with an example embodiment;

FIG. 12G presents various views of a lighting device having an aesthetic filter in accordance with an example embodiment;

FIG. 13A presents various views of an aesthetic filter for a lighting device in accordance with an example embodiment;

FIG. 13B presents various views of an aesthetic filter for a lighting device in accordance with an example embodiment;

FIG. 13C presents various views of an aesthetic filter for a lighting device in accordance with an example embodiment;

FIG. 13D presents various views of an aesthetic filter for a lighting device in accordance with an example embodiment;

FIG. 13E presents various views of an aesthetic filter for a lighting device in accordance with an example embodiment;

FIG. 13F presents various views of an aesthetic filter for a lighting device in accordance with an example embodiment;

FIG. 14 is a side view of an exemplary lighting installation on a soffit of a building;

FIGS. 15A-15C are representative images of variations on the lighting installation of FIG. 14;

FIG. 16 is a perspective view of an exemplary lighting unit;

FIG. 17 shows the lighting element installed within the track, with a display illuminating element exposed through a portion of the track;

FIG. 18 shows the track of FIG. 19, with an accent illuminating element exposed through another portion of the track;

FIG. 19 is a perspective view of the track, showing both accent and display illuminating elements exposed through the track;

FIG. 20 is a more detailed view of the track and display illuminating element;

### FIG. 21 show the Casing of the Lighting Unit, With a Blocking Ring Removed therefrom;

FIG. 22A is a perspective view of the lighting unit;

FIG. 22B is a perspective view of internal components of the lighting unit;

FIG. 22C is a side view of internal components of the lighting unit;

FIG. 22D is an exploded view of the lighting unit, with the casing removed, and the display lens and blocking ring removed from the internal base;

FIGS. 23A and 23B are exploded views of the display lens and blocking ring;

FIG. 23C is a side, cross-sectional view of the lighting unit;

FIG. 24 is a sectioned view of the track, showing locations of both display lens and highlight lens openings in the track;

FIG. 25 is an end view of the track;

FIGS. 26 and 27 are perspective views of the track.

### DESCRIPTION OF EMBODIMENTS

Although the following detailed description contains many specifics for the purpose of illustration, a person of ordinary skill in the art will appreciate that many variations and alterations to the following details can be made and are considered included herein. Accordingly, the following embodiments are set forth without any loss of generality to, and without imposing limitations upon, any claims set forth. It is also to be understood that the terminology used herein is for describing particular embodiments only, and is not intended to be limiting. Unless defined otherwise, all technical and scientific terms used herein have the same meaning as commonly understood by one of ordinary skill in the art to which this disclosure belongs. Also, the same reference numerals appearing in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, etc., to provide a thorough understanding of various embodiments. One skilled in the relevant art will recognize, however, that such detailed embodiments do not limit the overall concepts articulated herein but are merely representative thereof. One skilled in the relevant art will also recognize that the technology can be practiced without one or more of the specific details, or with other methods, components, layouts, etc. In other instances, well-known structures, materials, or operations may not be shown or described in detail to avoid obscuring aspects of the disclosure.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open-ended term in this written description, like “comprising” or “including,” it is understood that direct support should be afforded also to “consisting essentially of” language as well as “consisting of” language as if stated explicitly and vice versa.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a given term, metric, value, range endpoint, or the like. The degree of flexibility for a particular variable can be readily determined by one skilled in the art. However, unless otherwise expressed, the term “about” generally provides flexibility of less than 1%, and in some cases less than 0.01%. It is to be understood that, even when the term “about” is used in the present specification in connection with a specific numerical value, support for the exact numerical value recited apart from the “about” terminology is also provided.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of phrases including “an example” or “an embodiment” in various places throughout this specification are not necessarily all referring to the same example or embodiment.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, a data region that has an “increased” risk of corruption can refer to a region of a memory device which is more likely to have write errors to it than other regions in the same memory device. A number of factors can cause such increased risk, including location, fabrication process, number of program pulses applied to the region, etc.

An initial overview of embodiments is provided below, and specific embodiments are then described in further detail. This initial summary is intended to aid readers in understanding the disclosure more quickly and is not intended to identify key or essential technological features, nor is it intended to limit the scope of the claimed subject matter.

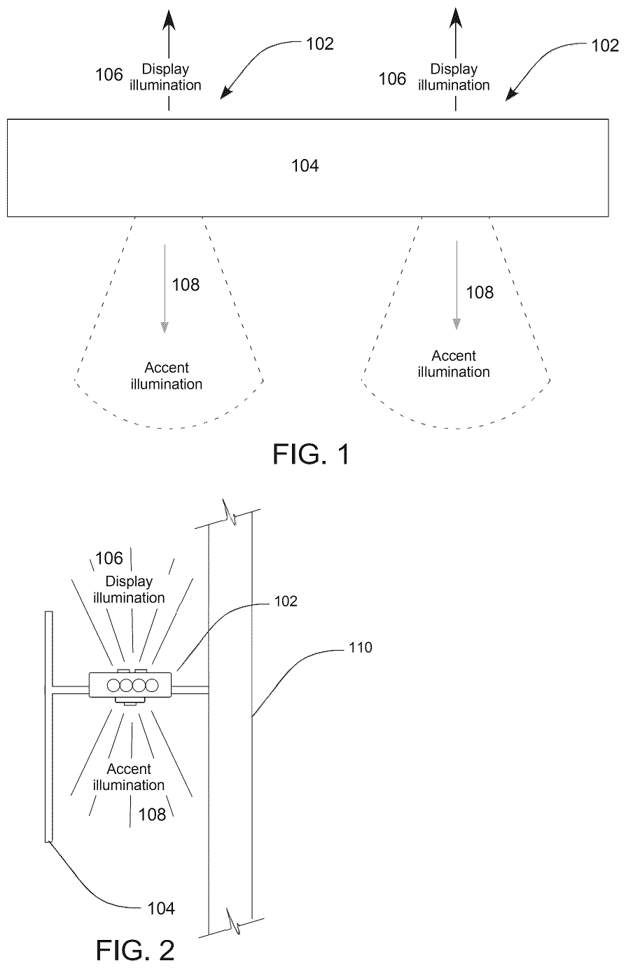

The presently disclosed technology provides a decorative light device, system, and method. The novel decorative light device, for example, includes multiple light sources oriented in different directions to generate direction-oriented light. Either light can range from bright display light to accent light. In one example, as depicted in FIG. 1, illumination from a pair of such multidirectional light devices 102 (light devices) is shown against a vertical structure, such as a building wall, but hidden behind a light support 104 to which, in some examples, they are mounted. Each light device 102 has a display illumination direction 106 and an accent illumination direction 108, or in other words, the light emits in a display light direction 106 and an accent light direction 108. For example, the display illumination 106 can be directed upward to provide brighter display lighting, such as would be the case for a decorative lighting scheme on a house, building, or other structure. One example of accent illumination can be directed against the building, either directed downward or directed toward the building to create a more subtle aesthetic or accent lighting effect.

FIG. 2 shows an example of a light device 102 mounted to a light support 104. The light support 104 is mounted to a support structure 110 and, in this case, hides the physical structure of the light device from view. Display illumination is directed upwards and accent illumination is directed downward in the opposite direction to provide light accents to the support structure.

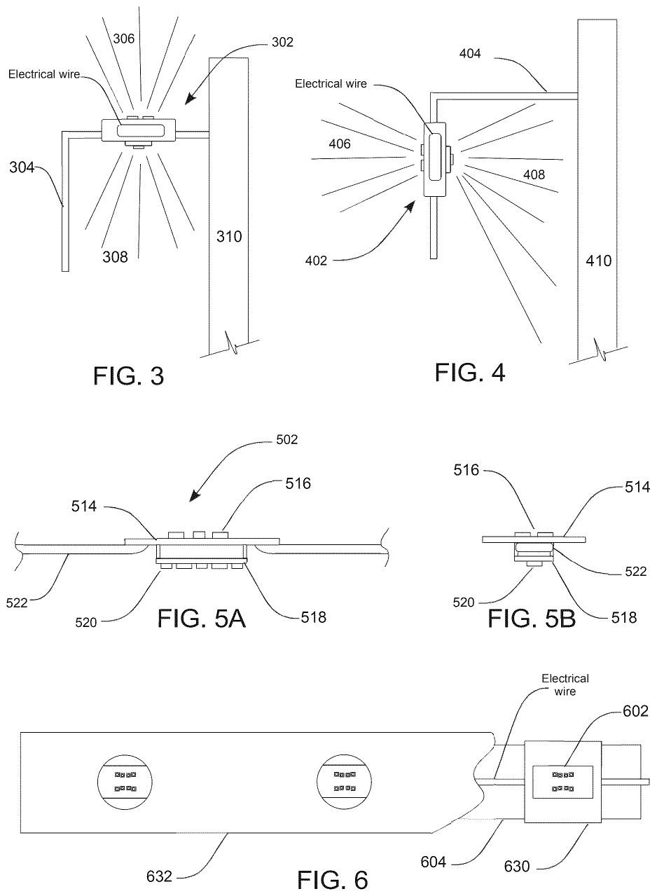

FIG. 3 shows a side view example of a light device 302 mounted to a light support 304 that is in turn mounted to a support structure 310. In this example, the light device 302 is mounted to a portion of the light support 304 that orients the display illumination 306 in an upward direction. The accent illumination 308 is oriented in the opposite direction compared to the display illumination 306.

FIG. 4 shows a side view example of a light device 402 mounted to a light support 404 that is in turn mounted to a support structure 410. In this example, the light device 402 is mounted to a portion of the light support 404 that orients the display illumination 406 in a direction away from the support structure 410, or in other words, in a direction that is generally perpendicular to, and away from, the support structure 410. The accent illumination 408 is oriented in the opposite direction compared to the display illumination 406, which in this case is toward the support structure 410.

FIG. 5A shows a side view example of a light device 502 having a display circuitry support 514 to which display illumination light elements 516 are electrically coupled and an accent circuitry support 518 to which accent illumination light elements 520 are electrically coupled. Illumination light elements can be any type of light-generating device, such as, for example, light emitting diodes (LEDs). For convenience, and without limitation, an illumination light element, an illumination diode, and the like, will be referred to as an “LED.”

The light device example of FIG. 5A further shows electrical wiring 522, which electrically couples multiple light devices 502 together and to an electrical source. The display circuitry support 514 and the accent circuitry support 518 are coupled relative to one another, with sufficient space therebetween to preclude electrical contact between electrical elements. The circuitry supports are oriented relative to one another such that the display LEDs and the accent LEDs are positioned to emit light in opposite directions.

FIG. 5B shows an end view example of the light device of FIG. 5A having a display circuitry support 514 to which display LEDs 516 are electrically coupled and an accent circuitry support 518 to which accent LEDs 520 are electrically coupled. The light device further shows electrical wiring 522, which electrically couples multiple light devices together and to an electrical source. The display circuitry support 514 and the accent circuitry support 518 are coupled relative to one another, with sufficient space therebetween to preclude electrical contact between electrical elements. The circuitry supports are oriented relative to one another such that the display LEDs and the accent LEDs are positioned to emit light in opposite directions.

It is additionally contemplated that the display LEDs and the accent LEDs can be mounted on a common circuitry support oriented in opposite directions. Furthermore, any number of circuitry supports, circuit elements, LEDs, electrical wires, etc., can be utilized in a given light device.

FIG. 6 shows an example of a series of light devices 602 mounted to a light support 604 that is a track structure such that the light devices 602 are mounted along the light support 604 in a positionally adjustable manner. In one aspect, a light device is mounted to a light adjustor 630, which allows the light device's 610 position to be adjusted by sliding along the light support. An illumination shroud 632 can be positioned relative to the light devices 602 to optically block or otherwise orient light emitting therefrom. The illumination shroud affects display illumination or accent illumination depending on which side (i.e., top or bottom) the illumination shroud is positioned relative to the light devices. Additionally, the illumination shroud can be positioned on both sides of the light support to thus affect the display and accent illumination.

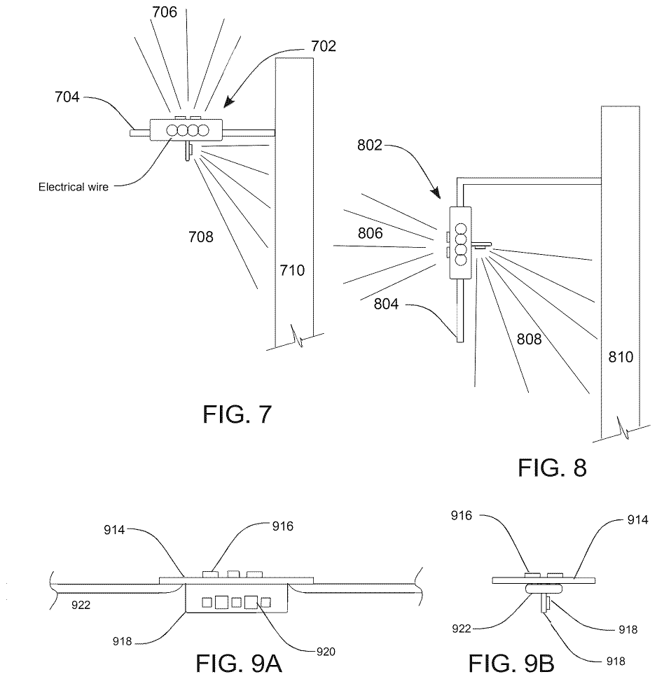

FIG. 7 shows an example of a light device 720 mounted to a light support 704 that is in turn mounted to a support structure 710. In this example, the light device 702 is mounted to a portion of the light support 704 that orients the display illumination 706 in an upward direction. Accent illumination 708 is oriented in a generally perpendicular direction compared to the display illumination 706, or in other words, toward the support structure 710.

FIG. 8 shows a side view example of a light device 802 mounted to a light support 804 that is in turn mounted to a support structure 810. In this example, the light device 802 is mounted to a portion of the light support 804 that orients the display illumination 806 in a direction away from the support structure 804, or in other words, in a direction that is generally perpendicular to, and away from, the support structure 804. Accent illumination 808 is oriented in a generally perpendicular direction compared to the display illumination 806. In this example, the accent illumination 808 is thus directed in a downward direction to emit accent illumination onto and downward along the support structure 810.

FIG. 9A shows a side view example of a light device 902 having a display circuitry support 914 to which display LEDs 916 are electrically coupled and an accent circuitry support 918 to which accent LEDs 920 are electrically coupled. The example further shows electrical wiring 922, which electrically couples multiple light devices together and to an electrical source. The display circuitry support 914 and the accent circuitry support 918 are coupled relative to one another in an orientation that provides the display and accent illumination directions relative to one another. For a light device 902 having the display and accent illumination oriented generally perpendicularly to one another, as in FIG. 9A, the accent circuitry support 918 is oriented generally perpendicularly to the display circuitry support 914. In one example, the circuitry supports can be physically mounted to one another. In another example, circuitry supports can be mounted relative to one another by a light device housing.

FIG. 9B shows an end view example of the light device 902 of FIG. 9A having a display circuitry support 914 to which display LEDs 916 are electrically coupled and an accent circuitry support 918 to which accent LEDs 920 are electrically coupled. The light device further shows electrical wiring, which electrically couples multiple light devices together and to an electrical source. The display circuitry support 914 and the accent circuitry support 918 are coupled relative to one another in an orientation that provides the display and accent illumination directions relative to one another.

It is additionally contemplated that the display LEDs and the accent LEDs can be mounted on a common circuitry support oriented in opposite directions. Furthermore, any number of circuitry supports, circuit elements, LEDs, electrical wires, etc., can be utilized in a given light device. It is additionally contemplated that the display circuitry support and the accent circuitry support can be coupled together at any useful angle to provide unique accent and display light effects.

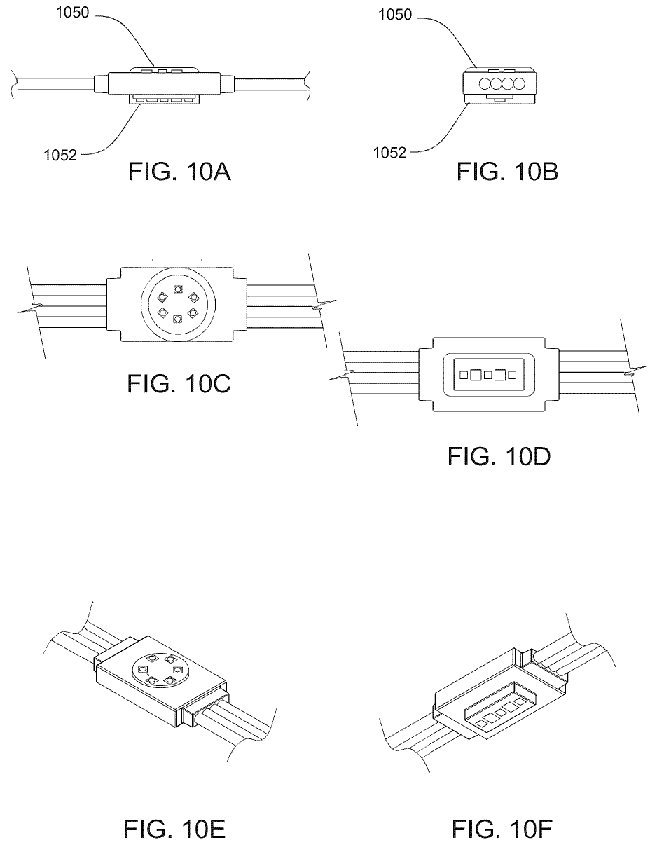

FIG. 10A shows a side view example of a light device with display LEDs and accent LEDs oriented opposite to one another. The light device further includes a protective case covering the display LEDs and the accent LEDs. The LEDs can be covered by a single protective case or multiple protective cases. The light device example of FIG. 10A further shows electrical wiring, which electrically couples multiple light devices together and to an electrical source.

FIG. 10B shows an end view example of the light device of FIG. 5A having display LEDs and accent LEDs oriented opposite to one another and covered with protective cases. The light device further shows electrical wiring, which electrically couples multiple light devices together and to an electrical source. FIGS. 10C-10F show top, bottom, and orthogonal views of the light device of FIGS. 10A and 10B. Additionally, FIG. 10 shows an upper protective case 1050 and a lower protective case 1052

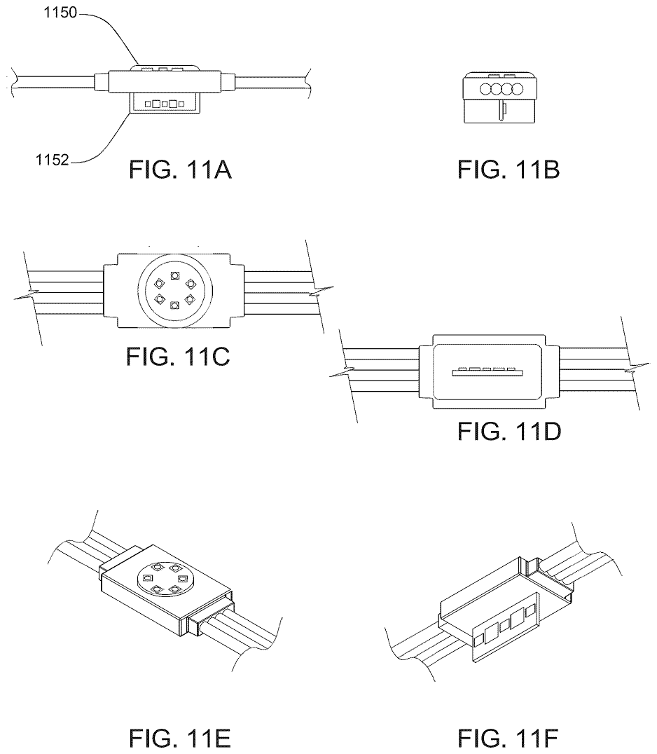

FIGS. 11A-11E shows side, end, top, bottom, and orthogonal view examples of a light device with display LEDs and accent LEDs oriented generally perpendicular to one another. The light device further includes a protective case covering the display LEDs 1150 and the accent LEDs 1152. The LEDs can be covered by a single protective case or multiple protective cases. The light device further shows electrical wiring, which electrically couples multiple light devices together and to an electrical source.

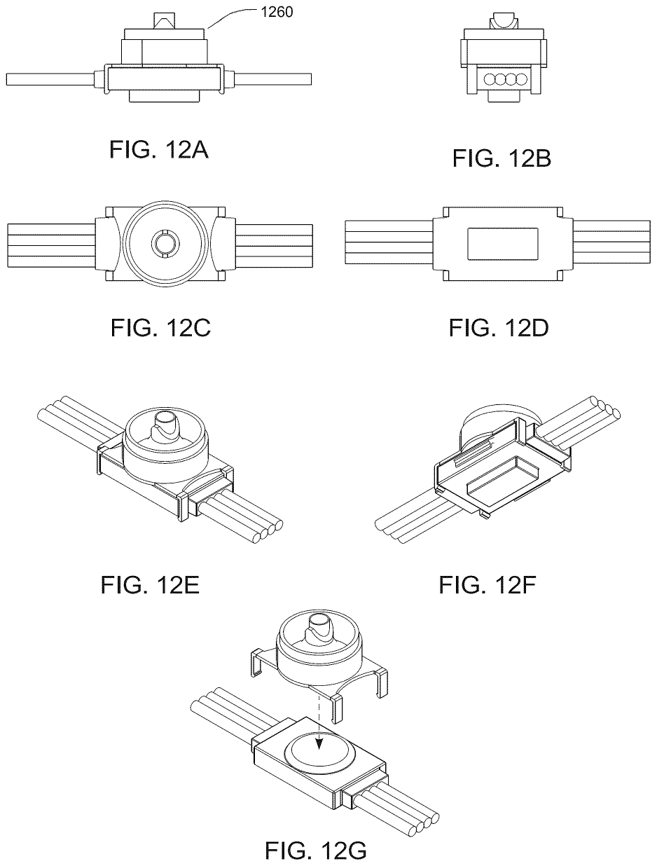

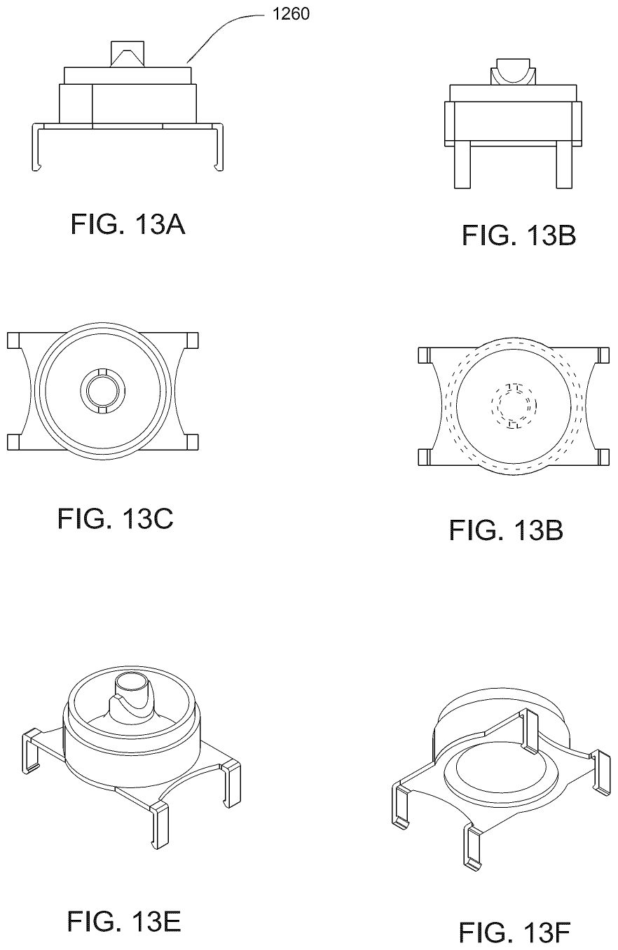

FIGS. 12A-12G shows side, end, top, bottom, and orthogonal view examples of a light device with display LEDs and accent LEDs that includes an aesthetic filter 1260. An aesthetic filter allows various effects to be applied to the emitted illumination, in this example to the display illumination. An aesthetic filter can be removable or non-removable. Various aesthetic filters are contemplated to apply various effects to the emitted illumination, such as color, warmth, flicker, etc. The aesthetic filter shown in FIGS. 12A-12G, for example, produces an incandescent light effect from LED light. The aesthetic filter is shown being removed from the light device in FIG. 12G.

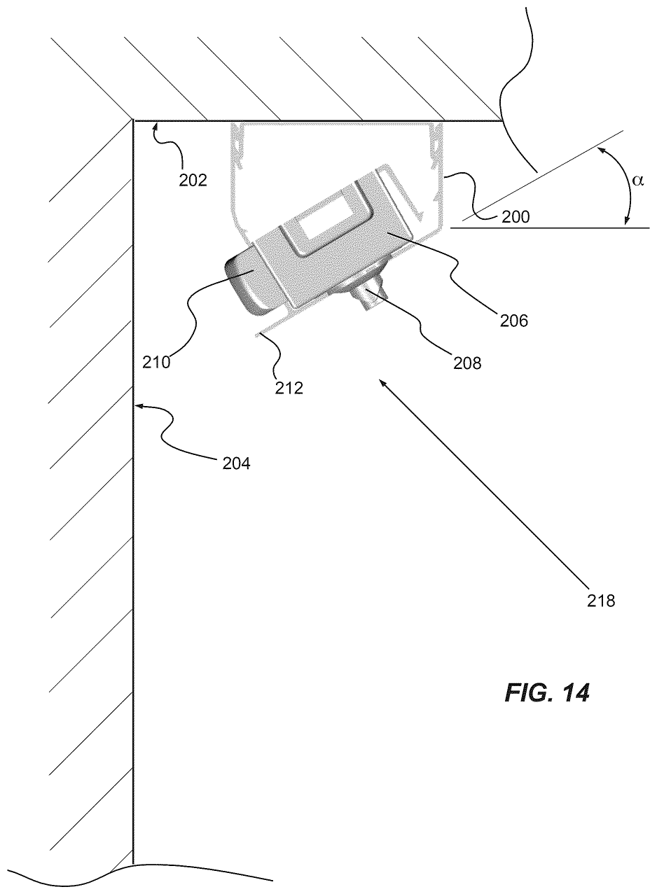

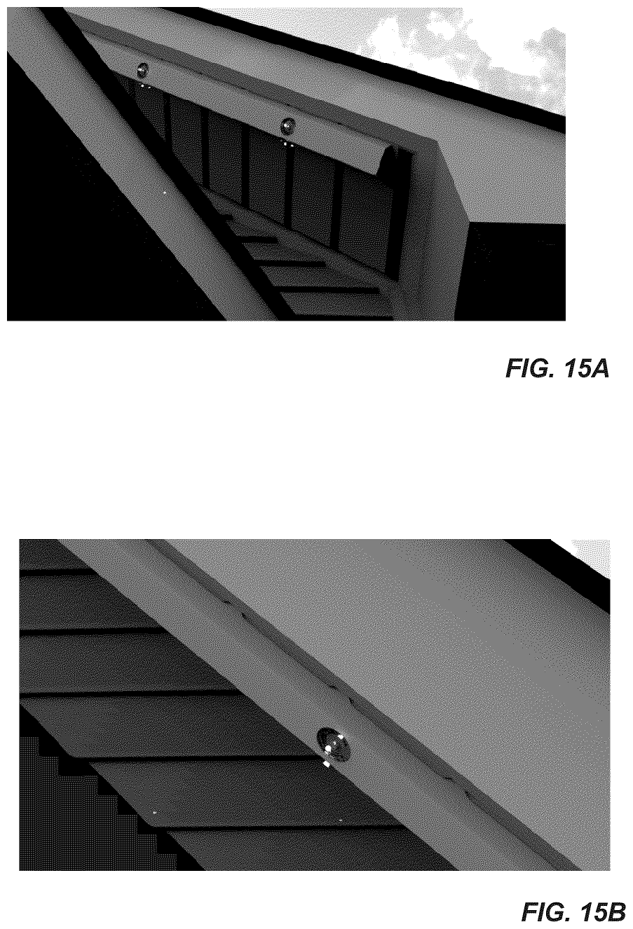

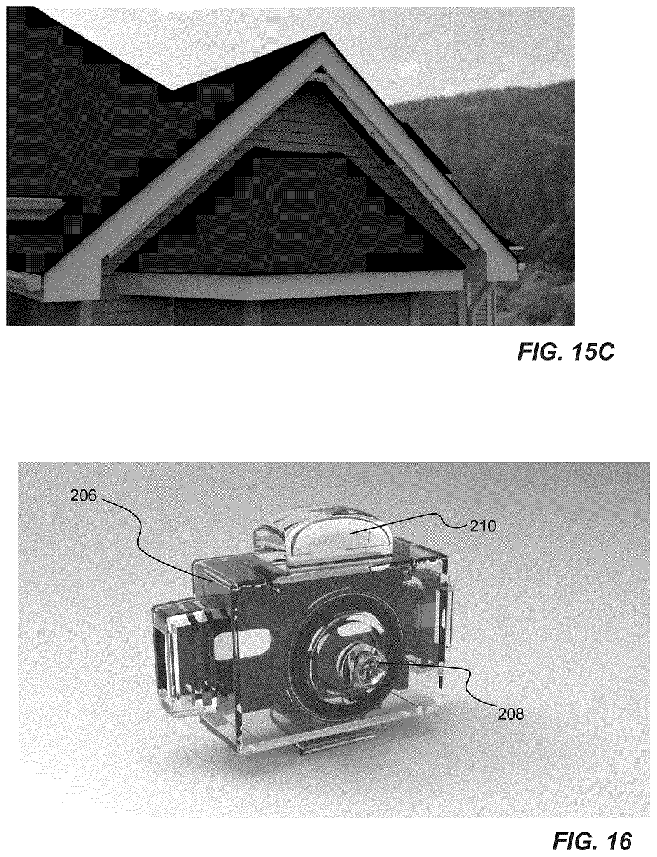

FIGS. 15A-15F shows side, end, top, bottom, and orthogonal view examples of the aesthetic filter from FIGS. 14A-14G.

The display illumination of the light devices can be operated independently from the accent illumination such as by, for example, a lighting controller. For example, the display illumination can be configured as holiday lighting, which can be switched off such that only accent illumination is active during non-holiday times or when only accent lighting is desired. Conversely, accent illumination can be turned off when holiday lighting alone is desired. In this manner, display lighting and accent lighting can be applied independently as desired to, for example, a roofline of a house.

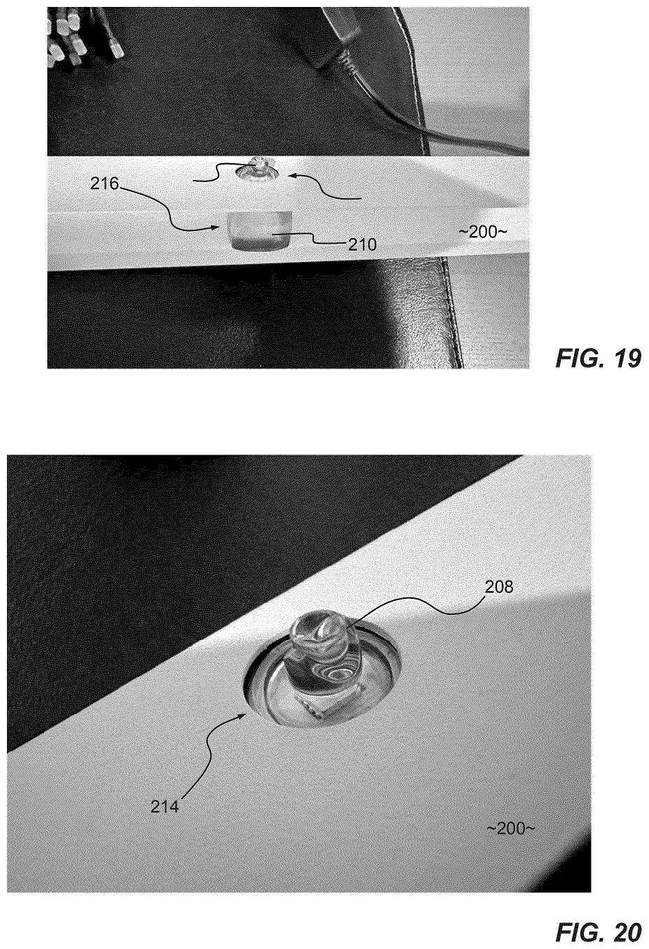

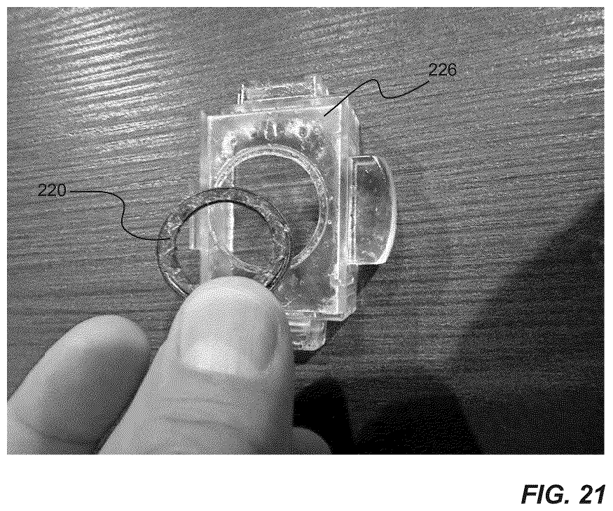

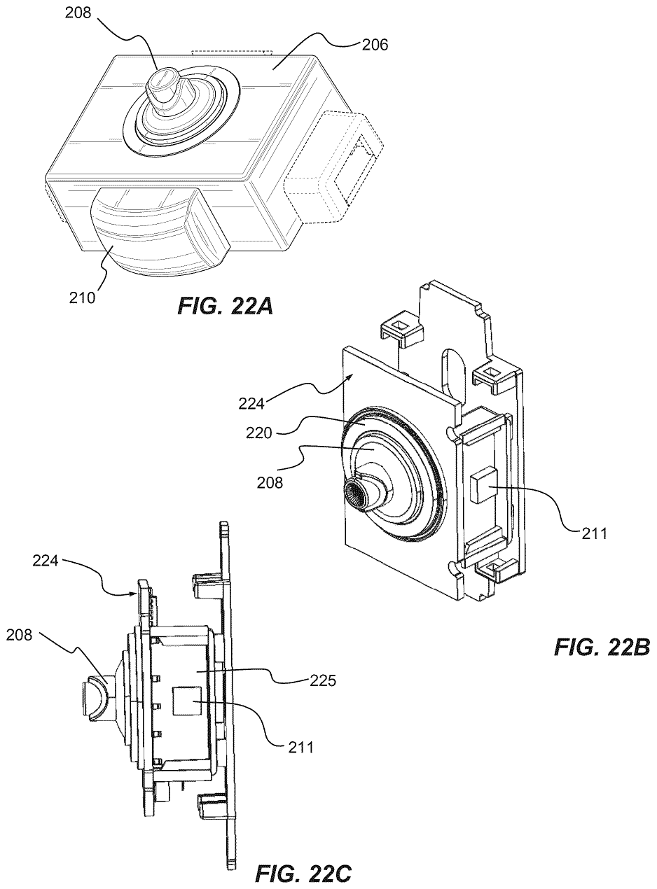

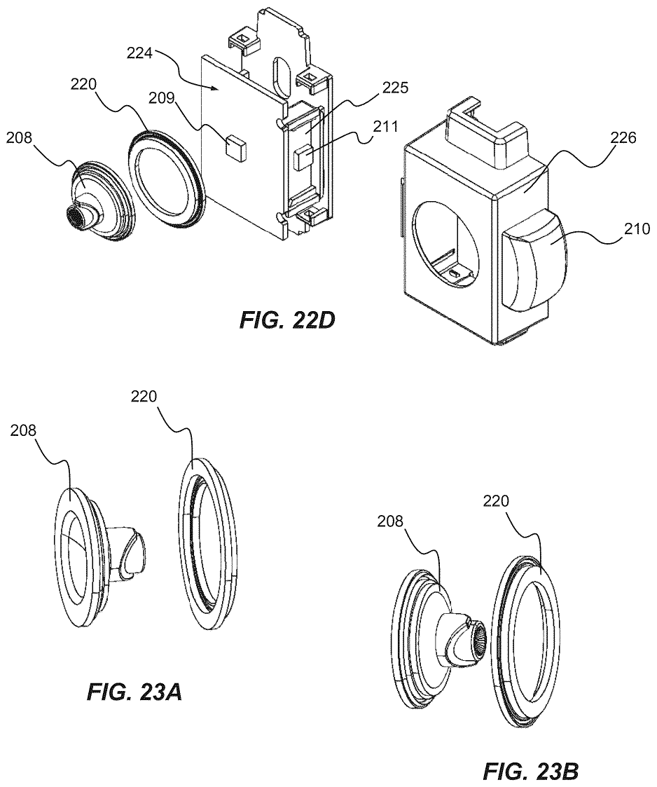

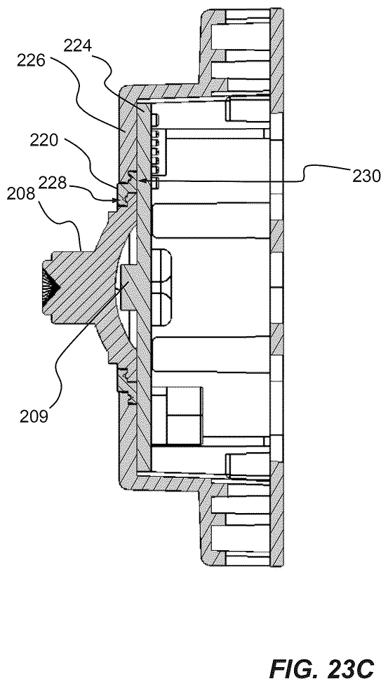

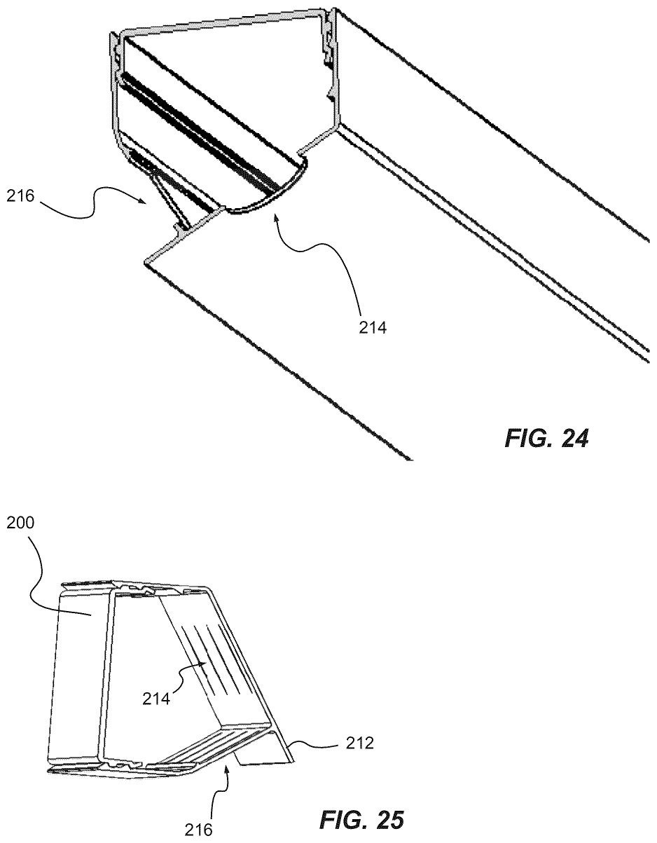

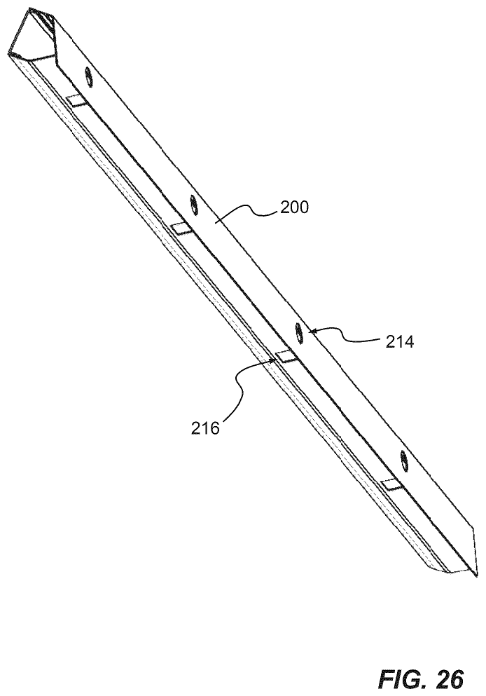

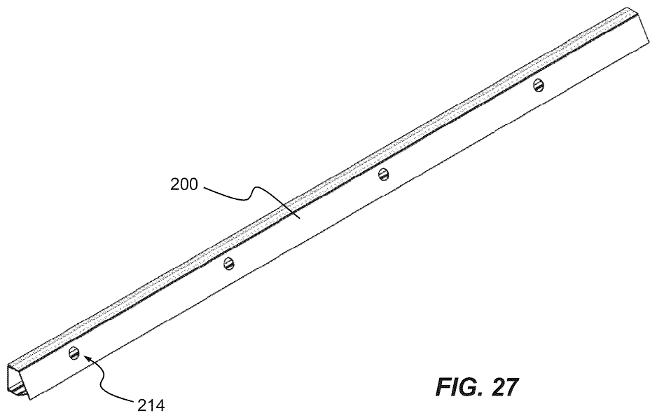

FIGS. 14-27 illustrate further embodiments of the technology. FIG. 14 is a side view of an exemplary track 200 in accordance with the present technology that is, in this embodiment, attached beneath a soffit 202 of a structure (for example, a house), with a wall of the house shown at 204. The track carry one or more lighting units 206. Each lighting can include a display lens 208 and an accent lens 210, which each protrude from, or emit light through, or are exposed through a respective display opening 214 or accent opening 216 (see, e.g., FIGS. 24 and 26). The track can include a shroud component or segment 212 that aids in blocking direct view of the accent light. For example, if a viewer is viewing the house along sight line 218, he or she can readily see display light or lens 208, but cannot directly see accent light or lens 210. The accent light or lens will, however, emit light toward the wall 204 to create a visually appealing lighting effect.

FIGS. 15 through 15C show alternate views of the exemplary installation. One exemplary lighting unit 206 is shown in perspective view in FIG. 16. The unit can include various hardware encased within a housing 226 (shown removed in FIGS. 21 and 22D). The hardware can include a display base 224 and an accent base 225, each with an accompanying emitter, 209, 211, respectively. Various connecting and or controlling circuitry can also be provided. The housing can be made from a partially or fully transparent or translucent material that can include or can merge into the material that forms the accent lens 208. While not so required, in one embodiment, the housing material can include or exhibit substantially the same translucency as does the accent lens. This can avoid requiring additional time, expense and materials to form the accent lens from a material that differs from the surrounding housing. The present technology advantageously can allow only light from an accent light emitter to enter the housing, if desired or not easily avoided, without mixing or combining that light with light from a display light emitter. Light emitted from a display light emitter can be directed through a specific lens, without mixing that light with the accent light.

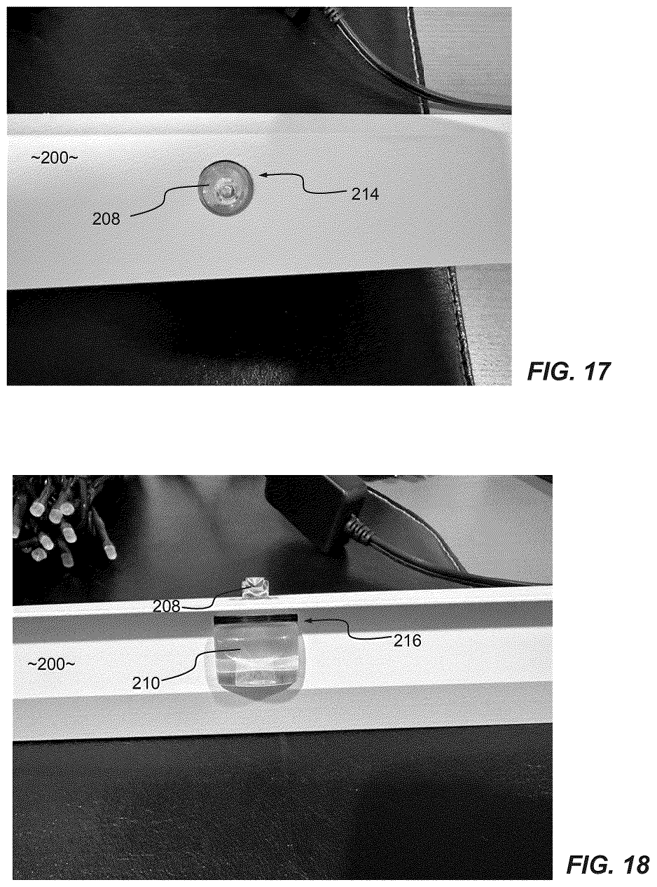

FIGS. 17 through 20 show the track 200 having at least one display lens opening 214, through which the display lens can protrude, or extend or be exposed. The track can also include at least one corresponding accent lens opening 216, through which the accent lens can protrude, or extend or be exposed. The lens opening can include a shape that form-fits a shape of the respective lens, so that the lighting unit is held securely and the light from each respective lens is controllably released relative to the track. In the nonlimiting examples shown, the accent light or lens is generally rectangular in shape, and the display light or lens is generally round in shape.

The system can include one or more fully or substantially opaque light blocking or “blackout” components that can prevent light from being emitted in particular directions. As shown in FIGS. 21 through 23B, in one example the system can include a blackout component or ring 220 that can be coupled to the casing 226. The blackout ring can be shaped to correspond to the lens or opening or other component for which it is intended to control light output. In the non-limiting examples shown, the ring is round in shape and receives within a retaining lip (228, FIG. 23C) the display lens 208 (see FIGS. 23A and 23B). When installed on the lighting unit, the blackout ring 220 essentially circumscribes the display light emitter or LED 209, and can include a substantially planar bottom (230, FIG. 23C) that can rest against, or be attached to, base 224. Base 224 can be formed of typical circuit board material, such as commonly used FR4 or the like. This material is typically opaque and so will not allow light to pass through it. As such, the blackout ring seated against it creates a light-tight enclosure. When the display lens 208 is installed within the blackout ring, all of the light generated by emitter 209 passes only through the display lens, as it is blocked on all other directions by either the blackout ring or the base.

This arrangement allows the controllable release of light from one of both emitters 209 (display) or 211 (accent). In this manner, the display lights in any particular channel or track can be programmed to produce one light effect, while the accent lights can be programmed to produce another light effect, and the display light effect will not interfere with the accent light effect. By arranging the blackout ring 220 as described, the casing 226 can be formed from material that need not block the passage of light (or at least not block it fully), as the display lens is isolated from the accent lens. Thus, while the housing may emit light generated from the accent emitter 211, this light is being emitted from the accent lens anyway, and so no disruption of the aesthetic effect results. The track can further block any light emitted by the housing, except from the desired display and accent lenses.

By positioning the track as shown in FIG. 14, a casual viewer, viewing along sight line 218, clearly views the effect produced by the display lens as distinct from the effect produced by the accent lenses, while his or her view of the accent lenses themselves is fully blocked. The angle “α” shown in FIG. 14 can be varied to achieve a desired level of visibility of light. In one, non-limiting example, this angle can be between about 25-45 degrees. In another example, this angle can be between about 30-35 degrees. The corresponding angle of the accent lens 210 and the shroud component 212 will vary as “α” is varied, thereby also adjusting the accent lighting affect in addition to the display lighting affect. This can be adjusted to obtain optimal visibility from the front curb of the home, while maintaining as low a profile of the track as possible.

I claim:

1. A multidirectional lighting device, comprising:
a lighting unit including:
a display light base carrying a display light emitter, the display light base being substantially opaque so as to prevent or limit light emitted from the display light emitter to pass therethrough; and
an accent light emitter;
a display lens receiving light from the display light emitter;
an at least partially translucent housing carrying an accent lens, the housing including a display lens opening through which the display lens protrudes; and
a light blocking ring:
substantially circumscribing a portion of the display light emitter;
fittable within the display lens opening of the housing; and
positioned atop the display light base;
the light blocking ring operable to block light emitted from the display lens from entering the housing so that light emitted from the display lens is isolated from light emitted by the accent light.

2. The lighting device of claim 1, wherein the accent lens is formed integrally with the housing.

3. The lighting device of claim 2, wherein the accent lens has the same translucency as the housing.

4. The lighting device of claim 1, wherein all components of the lighting device are contained within the housing.

5. The lighting device of claim 1, wherein the light blocking ring includes a retaining lip within which a portion of the display lens is receivable.

6. The lighting device of claim 5, wherein the light blocking ring includes a substantially planar bottom surface that sits atop the display light base and about the display light emitter.

7. The lighting device of claim 6, wherein the display lens extends from a front of the housing and the accent lens extends from a side of the housing.

8. The lighting device of claim 1, wherein the display light emitter is fully encompassed by the display lens and the display light base.

9. A multidirectional lighting device, comprising:
a lighting unit including:
a light base carrying at least one of a display light emitter and an accent light emitter, the light base being substantially opaque so as to prevent or limit light from passing therethrough;
an at least partially translucent housing enclosing the light base and having a lens opening formed therein, at least one of the display light emitter and the accent light emitter exposed through the lens opening;
a light blocking ring disposed at least partially within the lens opening, the light blocking ring being positioned adjacent the light base and about the one of the display light emitter and the accent light emitter exposed through the lens opening;
the light blocking ring operable to block light emitted from the one of the display light emitter and the accent light emitter exposed through the lens opening to prevent the light from entering the housing.

10. The lighting device of claim 9, wherein the light base carries the display light emitter, and further comprising an emitter light base carrying an accent light emitter.

11. The lighting device of claim 10, wherein the housing further includes an accent lens formed integrally therewith, the accent lens positioned adjacent the accent light emitter.

12. The lighting device of claim 11, wherein the accent lens has the same translucency as the housing.

13. The lighting device of claim 9, wherein all components of the lighting device are contained within the housing.

14. The lighting device of claim 9, wherein the light blocking ring includes a retaining lip within which a portion of the display lens is receivable.

15. The lighting device of claim 14, wherein the light blocking ring includes a substantially planar bottom surface that sits atop the display light base and about the display light emitter.

16. The lighting device of claim 15, wherein the display lens extends from a front of the housing and the accent lens extends from a side of the housing.

17. The lighting device of claim 9, wherein the display light emitter is fully encompassed by the display lens and the display light base.
